(19) United States
(12) Patent Application Publication
(10) Pub. No.: US 2026/0340414 A1
(43) Pub. Date: Oct. 29, 2026

(54) USING CONTEXT EXAMPLES DURING FINE-TUNING TO ADAPT GENERATIVE MODELS TO TASKS

(71) Applicant: GDM Holding LLC, Mountain View, CA (US)

(72) Inventors: Xu He, Montreal (CA); Jörg Bornschein, London (GB); Clare Marie Bennison Lyle, Seattle, WA (US); Amal Rannen-Triki, London (GB); Razvan Pascanu, Letchworth Garden City (GB); Yazhe Li, London (GB)

(21) Appl. No.: 19/465,879

(22) Filed: Jan. 30, 2026

Related U.S. Application Data
(60) Provisional application No. 63/751,803, filed on Jan. 30, 2025.

(51) Int. Cl. G06N 3/096; G06N 3/0475

(52) U.S. Cl. CPC G06N 3/096; G06N 3/0475

(57) ABSTRACT

Methods and systems are described for adapting a generative neural network to a downstream task by fine-tuning on augmented training data. A plurality of training examples is received, each including a training query and a target response. At each of a plurality of training steps, one or more current training examples are identified. For each of one or more training epochs at the training step, one or more context examples are selected for each current training example from a subset of the plurality of training examples that excludes the current training example. A modified training example is generated for each current training example, comprising the training query, a few-shot prompt that includes the selected context examples, and the target response. The generative neural network is then trained using the modified training examples.

### CROSS-REFERENCE TO RELATED APPLICATION

This application claims the benefit of priority to U.S. Application No. 63/751,803, filed on Jan. 30, 2025, the contents of which are hereby incorporated by reference.

### BACKGROUND

This specification relates to processing data using machine learning models.

Machine learning models receive an input and generate an output, e.g., a predicted output, based on the received input. Some machine learning models are parametric models and generate the output based on the received input and on values of the parameters of the model.

Some machine learning models are deep models that employ multiple layers of models to generate an output for a received input. For example, a deep neural network is a deep machine learning model that includes an output layer and one or more hidden layers that each apply a non-linear transformation to a received input to generate an output.

### SUMMARY

This specification generally describes a system implemented as computer programs on one or more computers in one or more locations that can adapt a generative model to a downstream task (e.g., a retrieval task, a generation task, etc.) by fine-tuning the generative model on task-specific training data that is augmented with few-shot prompts that include context examples.

Prior to the fine-tuning, the generative model can be trained on one or more pre-training data sets. Training the generative model on the one or more pre-training data sets can include, for example, training the generative model using unlabeled data through next token prediction, training the generative model on supervised data through fine-tuning, training generative model using instruction tuning techniques, training generative model using reinforcement learning from human feedback, etc.

In one aspect, there is provided a method performed by one or more computers, the method comprising: receiving a plurality of training examples, each training example comprising (i) a training query for a task to be performed and (ii) a target response to the training query. At each of a plurality of training steps, the method comprises identifying one or more current training examples for the training step; and for each of one or more training epochs: sampling one or more context examples for each current training example from a subset of the plurality of training examples that does not include the current training example; generating a modified training example for each current training example, each modified training example comprising (i) the training query, (ii) a few-shot prompt that comprises the sampled context examples, and (iii) the target response to the training query; and training a generative neural network using the modified training examples.

In some implementations, training the generative neural network includes training the generative neural network using gradients of an objective function that measures, for each modified training example, a likelihood assigned by the generative neural network to the target response in the modified training example by processing the training query and the few-shot prompt in the training example.

In some implementations, the likelihood is a log-likelihood.

In some implementations, prior to the training using the modified training example, the generative neural network has been trained on one or more pre-training data sets.

In some implementations, the method further includes, at each training step of the plurality of training steps, before training the generative neural network for the one or more training epochs at the training step: selecting a test training example from the plurality of training examples; selecting one or more test context examples from a second subset of the plurality of training examples that does not include the test training example; processing an input comprising (i) the training query of the test training example and (ii) a few-shot prompt that comprises the selected test context examples using the generative neural network to generate a training response to the training query; and updating a cumulative loss function based on a similarity between the target response to the training query and the training response to the training query.

In some implementations, the method further includes calculating a prequential loss metric using the cumulative loss function.

In some implementations, calculating the prequential loss metric includes, after performing the plurality of training steps, dividing the cumulative loss function by a number of training examples in the plurality of training examples.

In some implementations, identifying one or more current training examples for the training step includes selecting the test training example as a current training example.

In some implementations, updating the cumulative loss function includes: calculating a next step loss based on a similarity between the target response to the training query and the training response to the training query; and adding the next step loss to the cumulative loss function.

In some implementations, the training examples in the second subset of the plurality of training examples are the current training examples used to train the generative neural network at preceding training steps.

In some implementations, each modified training example further includes an instruction for the task.

In some implementations, for each training step, the same number of selected context examples is selected for each current training example for each training epoch.

In some implementations, the number of selected context examples for each current training example is the same as the number of selected test context examples.

In some implementations, the training examples in the subset of the plurality of training examples are the current training examples used to train the generative neural network at preceding training steps

In some implementations, selecting the one or more context examples for each current training example includes: determining whether more than a maximum number of current training examples have been used to train the generative neural network at preceding training steps; in response to determining that more than the maximum number of current training examples have not been used, selecting each of the current training examples that have been used to train the generative neural network at preceding training steps; and in response to determining that more than the maximum number of current training examples have been used, selecting the maximum number of current training examples from the current training examples that have been used to train the generative neural network at preceding training steps.

In some implementations, each training step is associated with a different one of the training examples; the one or more current training examples for each training step include only the training example associated with the training step; and a total number of training steps in the plurality of training steps is equal to a total number of training examples in the plurality of training examples.

In some implementations, the methods further includes, after training: receiving a query for a task to be performed; selecting one or more inference context examples from the plurality of training examples; generating a few-shot prompt comprising the selected inference context examples; and processing (i) the query and (ii) the few-shot prompt using the generative model to generate a response to the query.

In some implementations, each context example includes an image and a text segment, and wherein the generative neural network is trained to output a text segment.

In some implementations, each context example includes an image and an audio segment, and wherein the generative neural network is trained to output an audio segment.

In some implementations, each context example includes a text segment and a video, and wherein the generative neural network is trained to output a video.

In some implementations, each context example includes an audio file and a text segment, and wherein the generative neural network is trained to output a text segment.

The subject matter described in this specification can be implemented in particular embodiments so as to realize one or more of the following advantages.

The system described in this specification can adapt a generative model to a specific downstream task by using context examples in addition to task specific data while fine-tuning the generative model. Using context examples in addition to task specific data can efficiently and accurately adapt the generative model to the downstream task when limited training data is available for the downstream task.

One conventional approach for adapting generative models to a downstream task is to integrate context examples through a prompt, i.e., by including context examples as part of a prompt sequence that is processed as input by the generative model. Integrating context data through a prompt suffers from low scalability and the effectiveness of prompt-based methods can plateau as more context data becomes available. Another conventional approach for adapting generative models to new data is to fine-tune the generative model, i.e., by updating its existing weights using task-specific data. Modifying the weights of the generative model suffers from a higher training cost than prompt-based methods and decreased effectiveness when available training examples are scarce.

By contrast, this specification describes techniques for using context examples in the structure of a few-shot prompt in addition to task specific data while fine-tuning the generative model. This approach combines the efficiency of including context examples in a prompt processed by the generative model and the performance gains of fine-tuning the generative model. By incorporating task-specific context examples directly into the fine-tuning process, the generative model can learn more efficiently from limited data. Using context examples in addition to the task specific data while fine-tuning leverages generalization abilities of the generative model.

Additionally, the system can use a prequential approach for hyperparameter selection while fine-tuning the generative model. The system can first use a data point to test the performance of the generative model, and then incorporate the data point into the training data. This approach is useful in data-limited scenarios as it utilizes all available data for both testing and training the generative model, without needing a separation validation data set for hyperparameter tuning. The system can compare a cumulative or average performance across different hyperparameter configurations to identify high-performing settings without sacrificing training data. Using a prequential approach allows the system to reduce computational costs associated with evaluating the generative model on a separate validation data set.

When using a prequential approach, the system can leverage each data point multiple times across multiple training epochs for both future predictions and parameter optimization. After evaluation, each new data point can be used as a training example, as a context example included in a few-shot prompt associated with different training example, or as a context example included in a few-shot prompt associated with a query received by the generative model at inference.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example training system.

FIG. 2 is a flow diagram of an example process for training a generative neural network.

FIG. 3 is a flow diagram of an example process for using a prequential approach while training a generative neural network.

FIG. 4 illustrates an example of test accuracies for various methods for adapting a generative neural network to perform a first downstream task.

FIG. 5 illustrates an example of test accuracies for various methods for adapting a generative neural network to perform a second downstream task.

FIG. 6 illustrates an example of average performance for a downstream task across different model sizes.

Like reference numbers and designations in the various drawings indicate like elements.

### DETAILED DESCRIPTION

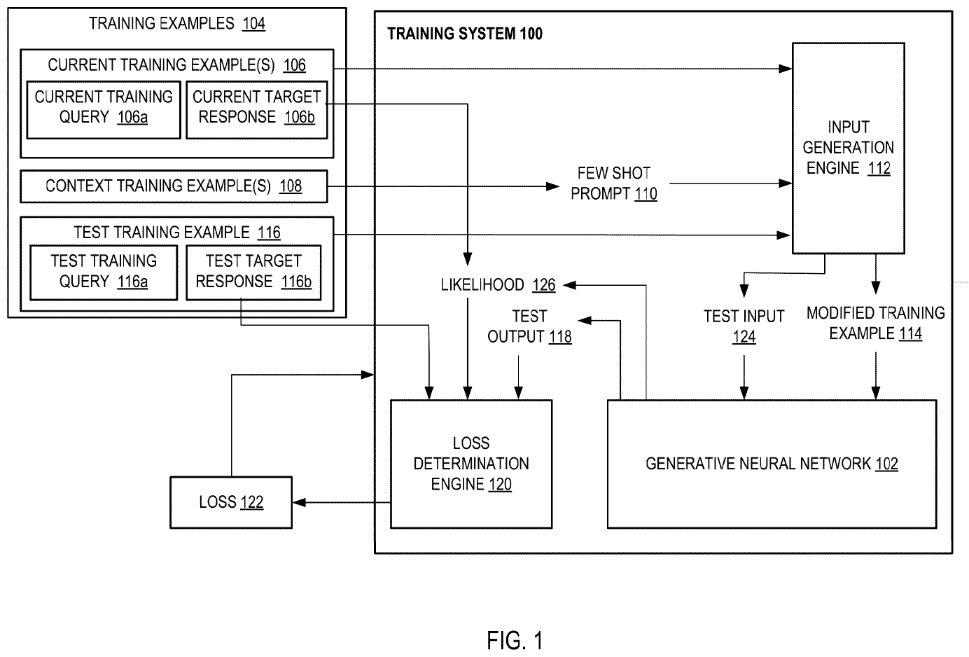

FIG. 1 is a block diagram of an example training system. The training system 100 is an example of a system implemented as computer programs on one or more computers in one or more locations in which the systems, components, and techniques described below are implemented.

The training system 100 includes a generative neural network 102, an input generation engine 112, and a loss determination engine 120.

The training system can adapt the generative neural network 102 to a downstream task.

The downstream task can be, for example, a multimodal task e.g., generating a text summary of an audio file or video file, generating an audio file that describes a navigation path between two written locations, generating a text response to a spoken question, generating a caption for an image, generating text that describes a relationship between two images, generating text that describes differences between two audio files, generating an image or a video based on a document, generating an image based on an audio file, etc.

As another example, the downstream task can be a question answering task e.g., generating a response to a question regarding the relationship between two people based on images depicting the two people, generating a response to an academic question, generating a response to a question about whether a given series of movements leads to a desired destination, etc.

As another example, the downstream task can be a text generation task, e.g., generating a completion of an input sequence of text, generating a response to a question posed in an input sequence of text, generating a sequence of text that is about a topic specified by an input sequence of text, generating an edited version of an input sequence of text, generating a summary based on an input sequence of text, etc.

As another example, the downstream task can be a code generation task, e.g., generating a completion of an input sequence code sequence, generating a code segment based on a goal that is specified in an input sequence of text, generating an edited version of an input code segment, etc.

As another example, the downstream task can be a translation task e.g., generating a sequence of text in one language that is a translation of an input sequence of text that is in a different language.

As another example the downstream task can be a classification task e.g., generating labels classifying each digit of a string of numbers as ‘even’ or ‘odd’, generating a label indicating whether an audio file is relevant to a particular topic, etc.

Prior to adaptation to the downstream task, the system 100 or another system can pre-train the generative neural network 102 on one or more pre-training data sets. The pre-training data sets can include a large number of training examples that are not specific to the downstream task. Training the generative model neural network 102 on the one or more pre-training data sets can include, for example, training the generative neural network using unlabeled data through next token prediction, training the generative model on supervised data through fine-tuning, training generative model using instruction tuning techniques, training generative model using reinforcement learning from human feedback, etc. Pre-training can be performed at a time that is separate from downstream task adaptation. The pre-training process can initialize parameters of the generative neural network 102 prior to adaptation by the system 100. After pre-training, the system can subsequently adapt the generative neural network 102 to the particular downstream task using task-specific context training examples.

To adapt the generative neural network 102 to the downstream task, the system can receive a set of training examples 104. Each training example 104 can include a training query for the downstream task and a corresponding target response to the training query. The target response can represent an expected output for the training query. The training examples can be task specific, e.g., include examples for the specific downstream task. For example, training examples 104 for an image captioning task can include an image as the training query and a descriptive text segment as the corresponding target response. For example, for a translation task, the training query and target response can be text segments in different natural languages with the same semantic meaning.

In some implementations, the set of training examples 104 can include a limited number of training examples. For example, the set of training examples can use tens or hundreds of training examples. In some examples, the set of training examples 104 can include fewer than 30 training examples, such as 3, 5, or 10 training examples. The training system 100 can effectively adapt the generative neural network 102 even when the number of training examples 104 is low, such as when only a small number of ground-truth examples are available for a specific downstream task.

At each of a series of training steps, the training system 100 can identify one or more current training examples 106 for the training step in the set of training examples 104. In some examples, each training step can be associated with a different training example. For example, a current training example 106 for a current training step can correspond to a training example that has not yet been used to train the generative neural network 102 at a preceding training step. For example, the training system 100 can sequentially select each training example in the set of training examples 104 as the current training example 106 for a corresponding training step.

In some examples, the training system 100 can identify multiple current training examples 106 for the training step. The training system 100 can process the current training examples in parallel. For example, the training system 100 can perform a batch training process.

The current training example 106 can include a current training query 106a and a current target response 106b.

As used in this specification, a training epoch can be a pass in which the training system 100 updates parameters of the generative neural network 102 using the current training example 106. In a given training step, the training system 100 can perform one or more training epochs for the same current training example 106. The training system 100 can perform one or more training epochs for the same current training example 106. Performing multiple training epochs allows the training system 100 to update the generative neural network 102 multiple times based on the same training example before the training system proceeds to a subsequent training step associated with a different current training example.

At each of the training epochs, the training system 100 can select one or more context training examples 108 for each current training example 106. The training system 100 can select the one or more context examples from a subset of training examples. The subset of training examples does not include the current training example 106. This can ensure that the current training example 106 is excluded from being selected as its own context.

In some examples, the subset of training examples from which the context training example 108 is selected includes the training examples that have been used as current training examples at preceding training steps. For example, for a fifth training step, the subset of training examples can include the training examples used as the current training examples in the four preceding training steps.

For a given training step and training epoch, the training system 100 can select a number of context training examples 108 for each current training example 106. In some examples, the number of selected context training examples 108 can be between 1 and 30, such as 1, 3, 5, 10, 15, 20, or 30 examples. In some examples, such as in many-shot regimes, the number of selected context training examples 108 can include up to 100 or 150 examples. The different training epochs within a given training step can have the same one or more current training example 106 but different context examples.

In some implementations, the training system 100 can limit a total number of context training examples 108 to a maximum number. For example, the training system 100 can determine whether more than the maximum number of current training examples 106 have been used to train the generative neural network 102 at preceding training steps. In response to determining that more than the maximum number of preceding training examples are not available, the training system 100 can select all available preceding training examples as context training examples 108. In response to determining that more than the maximum number of preceding training examples are available, the training system 100 can select exactly the maximum number of preceding training examples from the current training examples 106 used at preceding training steps for use as the context training examples 108.

For example, the maximum number can be set to five. When the training system 100 is currently at a third training step, the training system can identify that only two current training examples 106 from preceding steps are available. In this case, the training system 100 selects both available examples to generate the few-shot prompt 110. When the training system 100 is at a twentieth training step, the training system 100 identifies that nineteen preceding examples are available. Because nineteen exceeds the maximum number, the training system 100 selects exactly five context training examples 108 from the nineteen available preceding examples, such as through random sampling or by selecting the five most relevant examples to the current training query 106a.

In some examples, the training system 100 can randomly sample the context training examples 108 from the subset of training examples. For example, when the subset includes multiple training examples associated with preceding training steps, the training system 100 can randomly select a fixed number of context training examples. Random sampling allows the training system 100 to expose the generative neural network to different subsets of previously observed training examples.

In some examples, the training system 100 can select the context training examples 108 from the subset of training examples 104 based on relevance to the current training query 106a. For example, the training system 100 can determine the relevance based on a similarity between the current training query 106a and training queries of the training examples in the subset. The similarity can be based on a task type, a rule structure, or specific attributes described within the queries. In some examples, the similarity can be computed in an embedding space of an embedding neural network.

In some examples, the training system 100 can select the context training examples 108 can select context training examples 108 that involve similar underlying logic to the current training example 106. For example, for a reasoning task, the training system 100 can select context training examples 108 that describe similar logical structures or spatial relationships as those in the current training query 106a. For example, for a task involving symbol manipulation or language patterns, the training system 100 can select examples that demonstrate similar patterns of remapping or label inversion as required by the downstream task.

The training system 100 can use the selected context training examples 108 to generate a few-shot prompt 110. The few-shot prompt 110 can be formatted as a sequence of illustrative examples. For example, the few-shot prompt 110 can include multiple context examples arranged in a structured format, such as a series of “Next Example” blocks, where each block contains a query and a corresponding target response.

In some examples, the training system 100 can vary the number of context training examples 108 included in the few-shot prompt 110. For example, the training system 100 can generate the few-shot prompt 110 using a k-shot structure, where k represents the number of sampled context training examples 108. In some examples, the number of context examples 108 k can be a fixed value for all training steps. In some other examples, the number of context examples 108 k can be dynamically adjusted based on the availability of preceding training examples. For example, the few-shot prompt 110 can include between 1 and 30 context examples. In many-shot scenarios, the few-shot prompt 110 can include up to 150 or more context examples. Varying the number of context training examples 108 included in the few-shot prompt 110 can balance computational efficiency and predictive accuracy.

The input generation engine 112 can use the current training example 106 and the few-shot prompt 110 to generate a modified training example 114. For example, the input generation engine 112 can generate a modified training example for each current training example. Each modified training example can include the current training query 106a, the few-shot prompt 110 that includes the selected context examples, and the current target response 106b to the training query.

In some implementations, the input generation engine 112 can add a task instruction within the modified training example 114. For example, for a task involving modified label mappings, the input generation engine 112 can prefix the modified training example 114 with a text segment that identifies task-specific logic. The task instruction can guide the generative neural network 102 to learn a desired behavior.

In some examples, the input generation engine 112 can format the modified training example 114 as a sequence of tokens representing a unified input string. For example, the input generation engine 112 can arrange the sequence of tokens such that the few-shot prompt 110 precedes the current training query 106a and the current target response 106b. The tokens within the few-shot prompt 110 can include multiple pairs of context queries and context responses.

For example, the sequence of tokens can include one or more sets of context tokens. Each set of context tokens can include a task-specific query and a corresponding ground-truth answer, followed by the current training query 106a and the current target response 106b. In some examples, the input generation engine 112 can insert delimiter tokens, e.g., specific text strings or formatting characters, between the context training examples 108 and the current training example 106 to define the structure of the k-shot prompt.

In some implementations the tokens can represent text, e.g., words, wordpieces or characters, in a natural or computer language. For example, text may be received, e.g., as a series of encoded characters, e.g. UTF-8 encoded characters; such “characters” can include Chinese and other similar characters, as well as logograms, syllabograms and the like. A text encoder, i.e. a tokenizer, can process a sequence of text to represent the text as a series of text tokens from a vocabulary of text tokens, e.g. that each represent words, wordpieces or characters in a natural or computer language. The computer language may be any formal language used to communicate with a computer, e.g. a markup language, or a command or configuration language, or a data exchange language such as JSON, or a programming language. The tokenizer can, e.g., implement BPE (Byte Pair Encoding) or Wordpiece tokenization. Optionally the text can be obtained from audio data representing speech; the output tokens may be converted into audio data.

Also, or instead the tokens may represent an image. For example, a set (sequence) of input or output tokens can represent an image. Each image token may comprise a block encoding of values of the pixels in a different region of an image that maps a set of values of the pixels to a respective image token. The block encoder may comprise a neural network, e.g. having one or more (self-) attention layers, such as a Transformer neural network.

Also, or instead the tokens may represent an audio waveform. For example, a set (sequence) of input or output tokens can represent audio data representing a waveform e.g. instantaneous audio amplitude values or time-frequency audio data. Each image token may comprise a block encoding of the audio waveform in a different time segment of the audio that maps a set of values representing the audio waveform to a respective image token. The block encoder may comprise a neural network, e.g. having one or more (self-) attention layers, such as a Transformer neural network. In a multimodal system audio data or an image may be flagged by a start-of-audio token or start-of-image token.

The training system 100 can then train the generative neural network 102 using the modified training examples 114. During training, the generative neural network 102 can process each modified training example 114 to generate a corresponding output for the downstream task. The training system 100 can then utilize the generated output to optimize the generative neural network 102 for the specific downstream task.

During training, the system 100 can update parameters of the generative model using gradients of an objective function. For example, the objective function can measure, for each modified training example, a likelihood assigned by the generative model to the target response in the modified training example by processing the training query and the few-shot prompt in the training example.

For each current training example, the loss determination engine 120 calculates a loss 122 used to update the generative neural network 102. To calculate the loss 122, the loss determination engine 120 can evaluate the objective function. The generative neural network 102 assigns the likelihood 126 by processing an input sequence that includes the few-shot prompt 110 and the current training query 106a. In some implementations, the likelihood 126 is a log-likelihood.

For each of the training epochs, the training system 100 trains the generative neural network 102 using the modified training examples 114. During the training epochs, the training system 100 performs gradient steps to update parameters of the generative neural network 102. Specifically, the training system 100 computes gradients of the objective function based on the modified training examples 114. In some implementations, the training system 100 calculates gradients based on all target responses in the input sequence, including responses within the few-shot prompt 110 (e.g., target responses from the selected context training examples 108) and the current target response 106b. In some implementations, the training system 100 calculates gradients based on only the current target response 106b.

For each training epoch, the training system 100 can determine the gradient updates for the generative neural network 102 by evaluating the loss 122 for each modified training example 114. For example, the loss determination engine 120 can calculate the gradient updates based on an autoregressive loss across the entire few-shot prompt 110 such that the context examples inform the parameter adjustments. In some examples, the training system 100 determines the gradient updates by measuring the log-likelihood of the current target response 106b given the few-shot prompt 110 and the current training query 106a. In some examples, the training system 100 can use an optimizer, e.g., Adafactor, to update the parameters of the generative neural network 102 during the training epochs.

In some examples, the training system 100 can train the generative neural network 102 through a full fine-tuning process. In this process, the training system 100 updates all parameters of the generative neural network 102 based on the modified training examples 114. By adjusting the entire set of parameters, the training system 100 can enable the generative neural network 102 to learn task-specific patterns and nuances that might not be captured through more limited adaptation techniques. This full fine-tuning process can lead to performance improvements, e.g., when adapting a pre-trained model to a downstream task with unique logical or structural requirements.

In some other examples, the training system 100 can train the generative neural network 102 through parameter-efficient fine-tuning, where only a proper subset of the parameters of the generative neural network 102 are updated while other parameters remain fixed. For example, the training system 100 can employ a Low-Rank Adaptation (LoRA) technique to update a reduced number of parameters. The LoRA technique can include applying low-rank adapters to feed-forward modules or projection matrices within attention blocks of the generative neural network 102. By using low-rank adapters, the training system 100 can achieve predictive performance that is similar to full fine-tuning while significantly reducing memory requirements. Parameter-efficient approaches can be useful when adapting the generative neural network 102 using an optimizer with a reduced memory footprint.

During training, the generative neural network 102 can be updated across multiple training steps. The training steps include one or more respective training epochs that each include one or more parameter update operations. In addition to performing parameter updates, the training system 100 can also evaluate how effectively the generative neural network 102 is learning as the training proceeds across the multiple training steps. Rather than evaluating performance only after training has completed, the training system 100 can measure performance at different points during training. The training system can measure performance of the generative neural network before the execution of the one or more training epochs, e.g., before a given training example is used to update the generative neural network. Evaluating the generative neural network 102 prior to the training epochs enables the training system 100 to measure performance on data that has not yet influenced the model. The training system 100 can use the performance measurements to compare different hyperparameter settings and to select hyperparameter values that improve learning behavior during training,

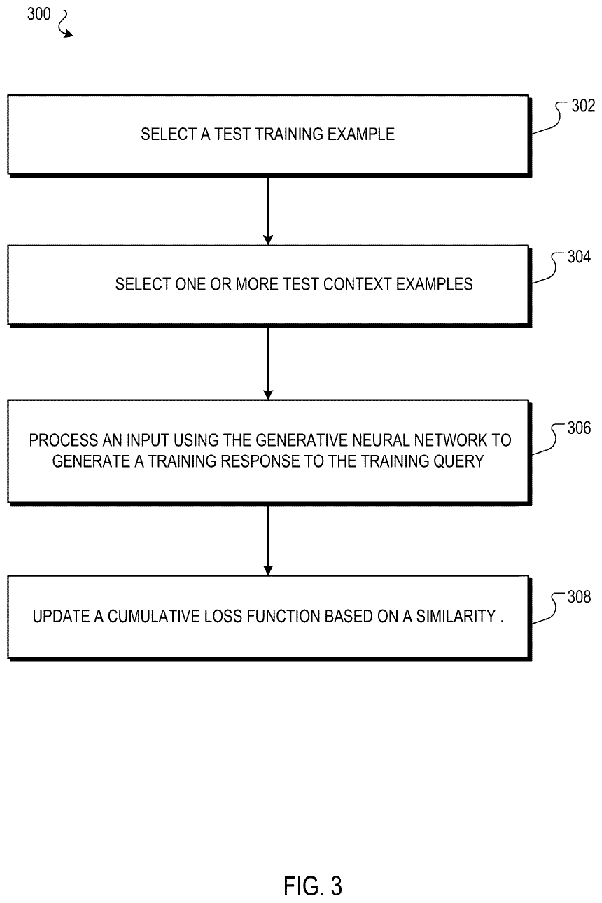

The training system 100 can use a prequential evaluation process (described below with reference to FIG. 3) to select hyperparameters for the generative neural network 102 and to evaluate the performance of the generative neural network 102. The generative neural network 102 can have hyperparameter values that are specific to a current training iteration. The training system 100 can optimize hyperparameters of the generative neural network 102 by selecting hyperparameter values that are associated with high (e.g., accurate) performance of the generative neural network 102. The hyperparameters can include, for example, a number of training epochs, a learning rate, a number of generative neural network layers, a number of context examples included in few-shot prompts 110, or a hyperparameter related to prompt construction or response parsing.

At the beginning of each training step, the training system 100 can first select a test training example 116 that has not been used for training the generative neural network 102 at any previous training step. The test training example 116 can include a test training query 116a and a test target response 116b. The training system 100 can select one or more test context examples, for example, from a subset of training examples 104 that does not include the test training example 116. The training system 100 can evaluate the performance of the generative neural network 102 in accordance with current values of the parameters of the generative neural network 102 using the selected test training example 116. The input generation engine 112 can use the test training examples 116 to generate a test input 124 that includes the test training query 116a and a few-shot prompt 110 that includes the test context examples to generate a test output 118. The generative neural network 102 can process the test input 124.

The loss determination engine 120 can update a cumulative loss function based on a similarity between the test output 118 of the generative neural network 102 and the test target response 116b. For example, the loss determination engine 120 can calculate a next-step loss based on a likelihood 126 assigned to the test target response 116b and add the next-step loss to the cumulative loss function.

Prior to the current training step, the cumulative loss function can represent an aggregation of next-step loss values calculated at one or more preceding training steps. Each next-step loss value corresponds to a similarity between a previously generated test output and a corresponding target response for a previously processed test training example. At an initial training step, before any test training examples have been evaluated, the cumulative loss function can be initialized to an initial value, e.g., zero or another baseline value.

At the current training step, the loss determination engine 120 calculates a next-step loss for the test training example 116 and adds the next-step loss to the cumulative loss function. The cumulative loss function can reflect the performance of the generative neural network 102 across the test training examples evaluated up to and including the current training step. After evaluating the performance of the generative neural network 102 using the test training example 116, the training system 100 can incorporate the test training example 116 into the training data as a current training example 106 for training the generative neural network 102 at the training step.

After the plurality of training steps are completed, the loss determination engine 120 can use the cumulative loss function to calculate a performance metric, such as a prequential loss or a prequential average accuracy, of the generative neural network 102 when using the current hyperparameter values. For example, the loss determination engine 120 can divide the cumulative loss function by a total number of training examples in the plurality of training examples 104 to calculate the performance metric.

The training system 100 can compare the performance metric with different performance metrics associated with different training iterations that use different hyperparameter values. The training system 100 can select final hyperparameters for the generative neural network 102 based on the hyperparameter values associated with a highest performance metric. This prequential approach can enable the training system 100 to utilize all available data points for both evaluation and training, eliminating the need for a separate validation set while providing a robust validation signal for hyperparameter selection. Because each training example is evaluated before being used to update the generative neural network 102 and then incorporated into training, the prequential approach allows all available data points to contribute to both evaluation and learning. This can yield a cumulative loss that reflects model performance across the entire dataset. In some implementations, the training system 100 uses the performance metric to perform model selection across different model sizes, such as selecting between a 2B, 9B, or 27B parameter version of the generative neural network 102.

In some implementations, the training system 100 can implement a training algorithm that performs the gradient updates and calculates the prequential loss using the algorithm described in Table 1 below. In one example, the training system initializes a cumulative loss function L to zero. For each training step i=1 to N, the training system identifies a training example as the current training example. The training system selects K context training examples from previously processed training examples The training system process an input that include the training query and the selected context training examples using the generative neural network to generate a training response. The training system computes a next-step loss based on a likelihood assigned by the generative neural network G to the target response rᵢ. The training system updates the cumulative loss function by adding the next-step loss. For each training epoch e=1 to E for the current training step, the training system selects K context training examples from previously processed training examples. The training system updates parameters of the generative neural network using gradients of an objective function based on a likelihood assigned by the generative neural network to the target response. After completing all training steps, the training system computes a prequential loss metric by dividing the cumulative loss function L by the number of training examples N. More specifically, the training system 100 can implement can use the algorithm described in Table 1, below.

TABLE 1
Training and Evaluation Algorithm

$Input \text{:} Dataset D = {\{ ( xi , yi ) \}}_{i = 1}^{N} ( N training examples )$
Number of in-context examples K
Gradient steps per example (number of epochs) E
Initial model parameters θ₀
Output: Model parameters θ_{N}
Avg. prequential performance metric L_{N}/N
L₀ ← 0
For i = 1 to N do:

| | |
|---|---|
| ctx~D_{<i} | (sample min(K, i) context examples) |
| ŷ_i~p( · \| ctx ⊕ xᵢ, θᵢ₋₁) | (predict yᵢ given xᵢ and k-shot context) |
| lᵢ = loss(ŷᵢ, yᵢ) | (next-step loss) |
| Lᵢ = Lᵢ₋₁ + lᵢ | (update cumulative loss) |

For 1 to E do:

| | |
|---|---|
| ctx~D_{<i} | (sample min(K, i) context examples) |
| θᵢ = θᵢ₋₁ − ∇_{θ} log p(ctx ⊕ xᵢ ⊕ yᵢ \| θᵢ₋₁) | (gradient step) |

```
        End
    End
```

After training, the trained generative neural network 102 can be used for inference on the downstream task. At inference, the generative neural network 102 can receive a query for the downstream task. The generative neural network 102 can select one or more inference context examples from the training examples 104, such as the training examples 104 used to train the generative neural network 102. In some implementations, the generative neural network 102 selects a number of inference context examples that corresponds to the number of context training examples 108 used during the fine-tuning process, e.g., between 1 and 30 examples. The generative neural network 102 can process an input sequence that includes the query for the downstream task and a few-shot prompt that includes the selected inference context examples to generate a response to the query. By conditioning the generative neural network 102 on these inference context examples at inference time, the generative neural network 102 can leverage the k-shot prompt structure that it was trained on to process the query.

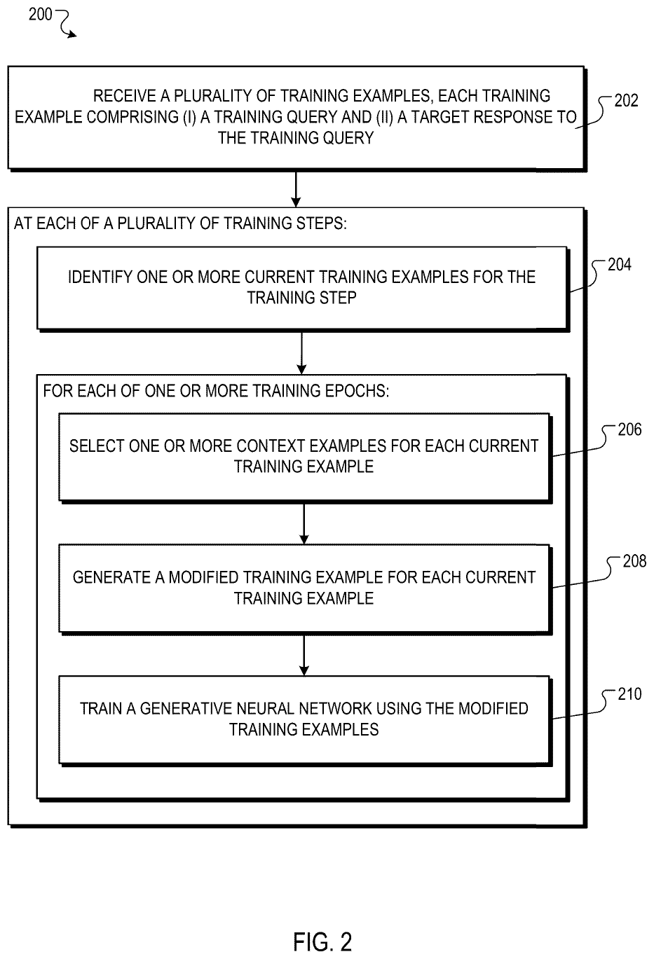

FIG. 2 is a flow diagram of an example process 200 for training a generative neural network. For convenience, the process 200 will be described as being performed by a system of one or more computers located in one or more locations. For example, a training system, e.g., the training system 100 of FIG. 1, appropriately programmed in accordance with this specification, can perform the process 200.

The system can train a generative neural network, e.g., the generative neural network 102 to perform a downstream task. The system can train the generative neural network across multiple training steps. Each training step corresponds to processing one or more training examples from a set of training examples.

Before performing the training steps, the system receives a plurality of training examples (202). Each training example includes a training query for a task to be performed and a target response to the training query. The training query and the target response can correspond to various modalities, such as text, images, audio, or video, depending on the nature of the task. For example, in a translation task, both the training query and the target response can include text segments. In an image captioning task, the training query can include an image and the target response can include a text segment.

At each training step, the system identifies one or more current training examples for the training step (204). In some implementations, the system associates each training step with a different training example from the plurality of training examples. For example, each training step can involve identifying a single training example that has not yet been processed as a test point. In some implementations, the system identifies a batch of training examples, such as 3, 5, or 10 training examples, for the training step.

For the training step, the system can update parameters of the generative neural network across one or more training epochs. The system can perform parameter update operations for the generative neural network across multiple training epochs associated with the current training example. The system can train the generative neural network across multiple training epochs before the system proceeds to a subsequent training step associated with a different current training example.

For each training epoch, the system selects one or more context examples for each current training example (206). The system selects the one or more context examples from a subset of the plurality of training examples that does not include the current training example. In some implementations, the system selects context examples that are relevant to the training query, such as examples that share a common task type or logical structure. Relevance can also be determined based on a similarity between the training query and training queries of the training examples in the subset.

In some implementations, the training examples in the subset of the plurality of training examples are the current training examples used to train the generative neural network at preceding training steps. In some implementations, selecting the one or more context examples for each current training example includes determining whether more than a maximum number of current training examples have been used to train the generative neural network at preceding training steps. In response to determining that more than the maximum number of current training examples have not been used, the system selects each of the current training examples that have been used to train the generative neural network at preceding training steps. In response to determining that more than the maximum number of current training examples have been used, the system selects the maximum number of current training examples from the current training examples that have been used to train the generative neural network at preceding training steps. For example, the maximum number can be between 1 and 30 examples, e.g., 5, 10, or 15 examples.

The system generates a modified training example for each current training example (208). Each modified training example includes the training query, a few-shot prompt that comprises the selected context examples, and the target response to the training query. The few-shot prompt can include a sequence of context queries and corresponding target responses formatted as illustrative examples. In some implementations, the system samples a plurality of context examples, and the few-shot prompt includes the sampled context examples. In some implementations, each modified training example further includes an instruction for the task, such as a verbal cue describing a mapping or rule to be followed by the generative neural network.

The system trains the generative neural network using the modified training examples (210). In some implementations, the system performs a full fine-tuning of the generative neural network where all parameters are updated. In some implementations, the system performs a parameter-efficient fine-tuning, such as by using Low-Rank Adaptation (LoRA) to update a subset of parameters. For example, the system can apply low-rank adapters to projection matrices within attention blocks of the generative neural network.

In some implementations, the system trains the generative neural network using gradients of an objective function. The objective function measures, for each modified training example, a likelihood assigned by the generative neural network to the target response in the modified training example. The system assigns the likelihood by processing the training query and the few-shot prompt in the modified training example. For example, the likelihood can represent the conditional probability of the target response given the preceding context examples and the current query. In some implementations, the likelihood is a log-likelihood.

In some implementations, prior to the training using the modified training example, the system trains the generative neural network on one or more pre-training data sets. For example, the generative neural network can be a foundation model that has undergone large-scale pre-training on broad data sets prior to being adapted to the specific downstream task.

In some implementations, each training step is associated with a different one of the training examples. In some examples, the one or more current training examples for each training step include only the training example associated with the training step. In some examples, a total number of training steps in the plurality of training steps is equal to a total number of training examples in the plurality of training examples. Each training example is used as the current training example at exactly one of the training steps. For example, the total number of training steps can include between 30 and 150 training steps.

In some implementations, after training, the system receives a query for a task to be performed. The system selects one or more inference context examples from the plurality of training examples. The system generates a few-shot prompt that includes the selected inference context examples. The system processes the query and the few-shot prompt using the generative neural network to generate a response to the query. In some implementations, the number of inference context examples is between 1 and 30, such as 5 or 10 context examples.

FIG. 3 is a flow diagram of an example process 300 for using a prequential approach while training a generative neural network. For convenience, the process 300 will be described as being performed by a system of one or more computers located in one or more locations. For example, a training system, e.g., the training system 100 of FIG. 1, appropriately programmed in accordance with this specification, can perform the process 300.

The system can perform the process 300 at each training step of a plurality of training steps, such as the training steps described above with reference to FIG. 2. The system can perform the process 300 before training a generative neural network for one or more training epochs at the training step. By evaluating the generative neural network using a test example before that example is incorporated into the training data for gradient-based updates, the system can obtain an unbiased estimate of the performance of the generative neural network.

The system selects a test training example from a plurality of training examples (302). The test training example can include a training query and a target response. In some implementations, the system selects the test training example such that it has not been used to train the generative neural network at any preceding training step.

The system selects one or more test context examples (304). The system can select the one or more test context examples from a subset of the plurality of training examples that does not include the test training example. In some implementations, the training examples in the subset are the current training examples used to train the generative neural network at preceding training steps. For example, for a training step i, the subset can include training examples sampled from the first i−1 observations. In some implementations, the system selects a fixed number of test context examples, such as between 1 and 30 examples.

The system processes an input using the generative neural network to generate a training response to the training query (306). The input can include the training query of the test training example and a few-shot prompt that includes the selected test context examples. The generative neural network can process the input to predict the target response given the test context examples.

The system updates a cumulative loss function based on a similarity between the target response to the training query and the training response to the training query (308). In some implementations, updating the cumulative loss function includes calculating a next-step loss. The system can calculate the next-step loss based on the similarity, such as by determining a log-likelihood assigned by the generative neural network to the target response or by calculating a prediction error. The system can then add the next-step loss to the cumulative loss function. The cumulative loss can be maintained throughout training steps across all the training steps.

In some implementations, the system identifies one or more current training examples for the training step by selecting the test training example as a current training example. After evaluating the next-step loss, the system can then incorporate the test training example into the training data to perform parameter updates for the generative neural network at the current training step.

In some implementations, the system can calculate a prequential loss metric using the cumulative loss function. In some implementations, calculating the prequential loss metric includes, after performing the plurality of training steps, dividing the cumulative loss function by the number of training examples in the plurality of training examples. The prequential loss metric can serve as a performance metric for hyperparameter selection, as it reflects the efficiency of the generative neural network in learning from sequential data. For each hyperparameter setting, the training system 100 can perform the entire set of training steps using that setting and track the resulting prequential loss. The training system 100 can then compare the prequential losses from different hyperparameter settings and choose the setting that leads to better overall learning performance.

In some implementations, for each training step, the same number of selected context examples is selected for each current training example for each training epoch. For example, the number of selected context examples for each current training example can be the same as the number of selected test context examples. This consistency enables the system to evaluate the generative neural network under conditions that match the training distribution.

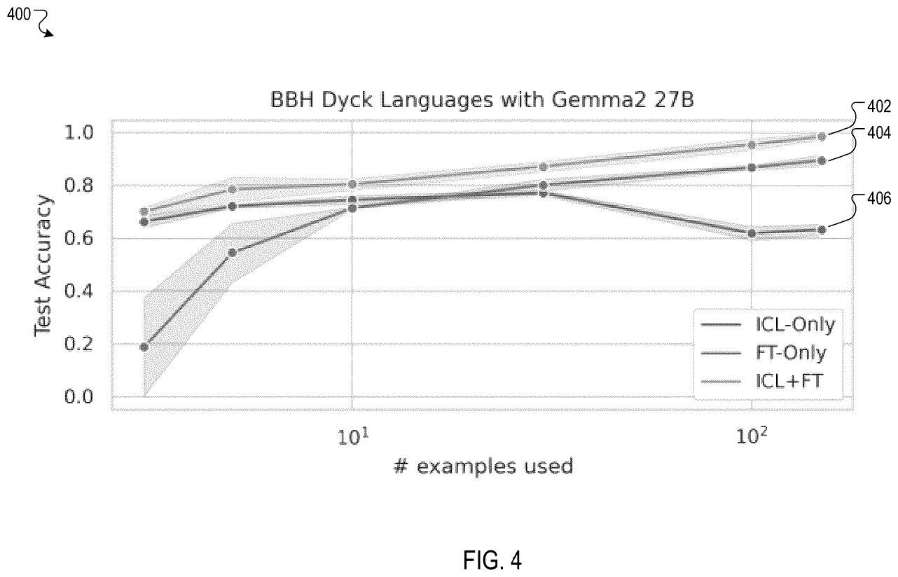

FIG. 4 illustrates an example 400 of test accuracies for various methods for adapting a generative neural network to perform a first downstream task. The example 400 shows a line graph comparing the performance of three adaptation processes—in-context learning plus fine-tuning (ICL+FT) 402, fine-tuning only (FT-Only) 404, and in-context learning only (ICL-Only) 406—on a languages task using generative neural network, e.g., the generative neural network 102 of FIG. 1. The y-axis represents test accuracy ranging from 0.0 to 1.0, and the x-axis represents the number of training examples used on a logarithmic scale from approximately 2 to 200.

As shown in FIG. 4, an ICL+FT process 402, e.g., the process performed by the system 100 of FIG. 1, consistently achieves a highest test accuracy across a range of training examples. For example, the ICL+FT process 402 starts at a baseline accuracy of approximately 0.7 and rises toward nearly 1.0 as a number of available examples increases. As illustrated, incorporating context examples into a fine-tuning process leverages sample efficiency while maintaining scaling benefits of gradient-based adaptation. A combination of in-context learning and fine-tuning can provide improved and more stable performance than either method used in isolation, particularly in data-limited regimes.

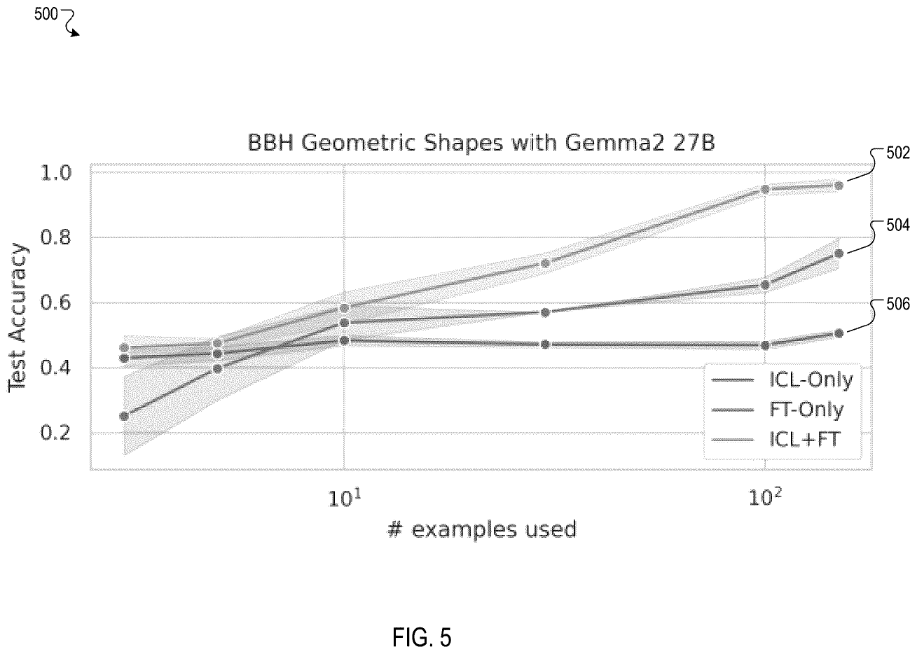

FIG. 5 illustrates an example 500 of test accuracies for various methods for adapting a generative neural network to perform a second downstream task. The example 500 shows a line graph comparing the performance of three adaptation processes—ICL+FT 502, FT-Only 504, and ICL-Only 506—on a geometric shapes task using a generative neural network, e.g., the generative neural network 102 of FIG. 1. The y-axis represents test accuracy ranging from 0.2 to 1.0, and the x-axis represents a number of training examples used on a logarithmic scale from approximately 2 to 200.

As shown in FIG. 5, the ICL+FT process 502, e.g., the process performed by the training system 100 of FIG. 1, achieves a highest test accuracy, following a strong upward trajectory as the number of examples increases. In particular, the ICL+FT process 502 demonstrates scaling benefits after approximately 30 examples, reaching an accuracy level near 1.0. In contrast, the ICL-Only process 506 rises slightly from a baseline of approximately 0.4 but plateaus and remains relatively flat around 0.5 accuracy regardless of additional training examples. As illustrated, a combination of in-context learning and fine-tuning can provide improved scaling and predictive performance compared to methods that rely on illustrative prompts or standard parameter updates.

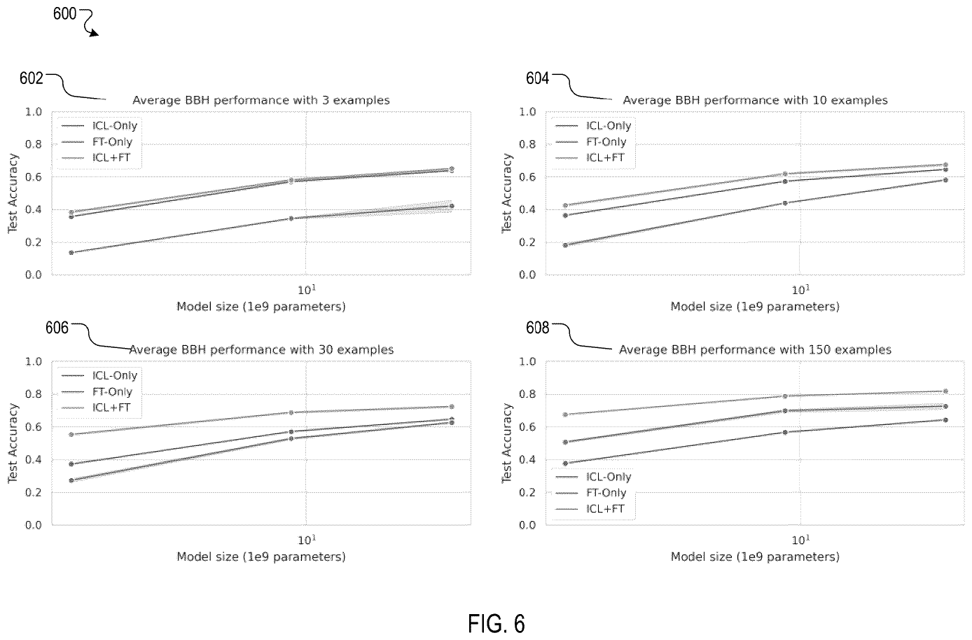

FIG. 6 illustrates an example 600 of average performance for a downstream task across different model sizes (e.g., ranging from 2 billion to 27 billion parameters). The example 600 includes four graphs 602, 604, 606, and 608 comparing an ICL+FT process, an FT-Only process, and an ICL-Only process for various training data budgets.

Graph 602 illustrates average performance when using three training examples. Graph 604 illustrates average performance when using ten training examples. Graph 606 illustrates average performance when using thirty training examples. Graph 608 illustrates average performance when using one hundred and fifty training examples. In each graph, the x-axis represents model size on a logarithmic scale and the y-axis represents test accuracy.

As illustrated in FIG. 6, the ICL+FT process, e.g., performed by the system 100 of FIG. 1, consistently achieves higher test accuracy than the individual FT-Only and ICL-Only processes across all model sizes and data budgets. As shown in the progression from graph 602 to graph 608, a performance gap between the ICL+FT process and the other processes can widen as a number of training examples increases. This suggests that the ICL+FT process leverages scaling benefits of fine-tuning more effectively than the other adaptation processes.

As illustrated in the example 600, the ICL+FT process can enable a smaller model (e.g., a 2B or 9B parameter model) to achieve a performance level that matches or exceeds the performance of an ICL-Only process using a model that is significantly larger (e.g., a 27B parameter model). This can improve computational efficiency, as the ICL+FT process can reduce the data and parameter requirements necessary to reach a target accuracy for a downstream task.

A generative neural network, e.g., the generative neural network 102 described above with reference to FIG. 1, can be configured to perform a generative task to generate, as output, data that includes, for example, text data, image data, video data, audio data, or multimodal data that includes data in two or more different modalities.

Some examples of machine learning tasks, including generative tasks, that the generative neural network when implemented using one of the architectures described below or other known architectures can be configured to perform follow.

In some cases, the generative neural network is a neural network that is configured to perform an image processing task, i.e., receive a network input that includes an image and to process the image to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. In some other cases, the neural network is a neural network that is configured to perform an image generation task, where the input is a conditioning input, and the output is a sequence of intensity value inputs for the pixels of an image.

As one example, the task may be a neural machine translation task. For example, if the network input to the generative neural network is a sequence of text, e.g., a sequence of words, phrases, characters, or word pieces, in one language, the network output generated by the neural network may be a translation of the sequence of text into another language, i.e., a sequence of text in the other language that is a translation of the input sequence of text. The vocabulary for the input tokens may be words, wordpieces or characters of the first language, and the vocabulary for the output tokens may be words, wordpieces or characters of the other language. As a particular example, the task may be a multi-lingual machine translation task, where a single neural network is configured to translate between multiple different source language-target language pairs. In this example, the source language text may be augmented with an identifier that indicates the target language into which the neural network should translate the source language text.

Some implementations may be used for automatic code generation. For example, the input tokens may represent words, wordpieces or characters in a first natural language and the output tokens may represent instructions in a computer programming or markup language, or instructions for controlling an application program to perform a task e.g. build a data item such as an image or web page.

As another example, the task may be an audio processing task. For example, if the network input to the generative neural network is a sequence representing a spoken utterance, the network output generated by the neural network may be a score for each of a set of pieces of text, each score representing an estimated likelihood that the piece of text is the correct transcript for the utterance. As another example, if the network input to the neural network is a sequence representing a spoken utterance, the network output generated by the neural network can indicate whether a particular word or phrase (“hotword”) was spoken in the utterance. As another example, if the network input to the generative neural network 102 is a sequence representing a spoken utterance, the network output generated by the neural network can be a classification of the spoken utterance into one of a plurality of categories, for example an identity of the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the network input is text in a natural language or features of text in a natural language and the network output is a spectrogram, a waveform, or other data defining audio of the text being spoken in the natural language.

As another example, the task can be a health prediction task, where the network input is a sequence derived from electronic health record data for a patient and the network output is a prediction that is relevant to the future health of the patient, e.g., a predicted treatment that should be prescribed to the patient, the likelihood that an adverse health event will occur to the patient, or a predicted diagnosis for the patient. Such electronic health data may, for example, comprise one or more sequences of physiological data taken from a patient, with the output being a corresponding prediction that relates to those sequences of data. Examples of physiological data and a corresponding prediction include: blood glucose measurements, with the prediction being a predicted future blood glucose measurement or the prediction of a hyper- or hypo-glycemic event; a heart rate, with the prediction being the presence or absence of a heart condition, or a future cardiac event; blood pressure measurements, with the prediction being the risk of a future heart condition; or the like.

As another example, the task can be a text generation task, where the network input is a sequence of text, and the network output is another sequence of text, e.g., a completion of the input sequence of text, a response to a question posed in the input sequence, or a sequence of text that is about a topic specified by the first sequence of text. As another example, the network input to the text generation task can be an input other than text, e.g., an image, and the network output sequence can be text that describes the network input.

In some implementations the input sequence represents data to be compressed, e.g. image data, text data, audio data, or any other type of data, and the output sequence a compressed version of the data. The input and output tokens may each comprise any representation of the data to be compressed/compressed data e.g. symbols or embeddings generated/decoded by a respective neural network.

As another example, the task can be an agent control task, where the network input is a sequence of observations or other data characterizing states of an environment and the network output defines an action to be performed by the agent in response to the most recent data in the sequence. The agent can be, e.g., a real-world or simulated robot, a control system for an industrial facility, or a control system that controls a different kind of agent. The observations may comprise sensor data captured by sensors associated with (e.g. part of) the agent, for example visual data, LIDAR data, sonar data, agent configuration data (e.g. joint angles), agent orientation data, or the like.

In some implementations, the environment is a real-world environment, the agent is a mechanical (or electro-mechanical) agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot interacting with the environment to accomplish a specific task, e.g., to locate or manipulate an object of interest in the environment or to move an object of interest to a specified location in the environment or to navigate to a specified destination in the environment.

In these implementations, the observations may include, e.g., one or more of: images, object position data, and sensor data to capture observations as the agent interacts with the environment, for example sensor data from an image, distance, or position sensor or from an actuator. For example, in the case of a robot, the observations may include data characterizing the current state of the robot, e.g., one or more of: joint position, joint velocity, joint force, torque or acceleration, e.g., gravity-compensated torque feedback, and global or relative pose of an item held by the robot. In the case of a robot or other mechanical agent or vehicle the observations may similarly include one or more of the position, linear or angular velocity, force, torque or acceleration, and global or relative pose of one or more parts of the agent. The observations may be defined in 1, 2 or 3 dimensions, and may be absolute and/or relative observations. The observations may also include, for example, sensed electronic signals such as motor current or a temperature signal; and/or image or video data for example captured by a camera or a LIDAR sensor, e.g., data from sensors of the agent or data from sensors that are located separately from the agent in the environment.

In these implementations, the actions may be control signals to control the robot or other mechanical agent, e.g., torques for the joints of the robot or higher-level control commands, or the autonomous or semi-autonomous land, air, sea vehicle, e.g., torques to the control surface or other control elements e.g. steering control elements of the vehicle, or higher-level control commands. The control signals can include for example, position, velocity, or force/torque/acceleration data for one or more joints of a robot or parts of another mechanical agent. The control signals may also or instead include electronic control data such as motor control data, or more generally data for controlling one or more electronic devices within the environment the control of which has an effect on the observed state of the environment. For example in the case of an autonomous or semi-autonomous land or air or sea vehicle the control signals may define actions to control navigation e.g. steering, and movement e.g., braking and/or acceleration of the vehicle.

In some implementations the environment is a simulation of the above-described real-world environment, and the agent is implemented as one or more computers interacting with the simulated environment. For example, a system implementing the generative neural network 102 may be used to select actions in the simulated environment during training or evaluation of the system and, after training, or evaluation, or both, are complete, the action selection policy may be deployed for controlling a real-world agent in the particular real-world environment that was the subject of the simulation. This can avoid unnecessary wear and tear on and damage to the real-world environment or real-world agent and can allow the control neural network to be trained and evaluated on situations that occur rarely or are difficult or unsafe to re-create in the real-world environment. For example the system may be partly trained using a simulation of a mechanical agent in a simulation of a particular real-world environment, and afterwards deployed to control the real mechanical agent in the particular real-world environment. Thus in such cases the observations of the simulated environment relate to the real-world environment, and the selected actions in the simulated environment relate to actions to be performed by the mechanical agent in the real-world environment.

In some implementations, as described above, the agent may not include a human being (e.g. it is a robot). Conversely, in some implementations the agent comprises a human user of a digital assistant such as a smart speaker, smart display, or other device. Then the information defining the task can be obtained from the digital assistant, and the digital assistant can be used to instruct the user based on the task.

For example, a system implementing the generative neural network may output to the human user, via the digital assistant, instructions for actions for the user to perform at each of a plurality of time steps. The instructions may for example be generated in the form of natural language (transmitted as sound and/or text on a screen) based on actions chosen by the system. The system chooses the actions such that they contribute to performing a task. A monitoring system (e.g. a video camera system) may be provided for monitoring the action (if any) which the user actually performs at each time step, in case (e.g. due to human error) it is different from the action which the system instructed the user to perform. Using the monitoring system the system can determine whether the task has been completed. The system may identify actions which the user performs incorrectly with more than a certain probability. If so, when the system instructs the user to perform such an identified action, the system may warn the user to be careful. Alternatively or additionally, the system may learn not to instruct the user to perform the identified actions, i.e. ones which the user is likely to perform incorrectly.

More generally, the digital assistant instructing the user may comprise receiving, at the digital assistant, a request from the user for assistance and determining, in response to the request, a series of tasks for the user to perform, e.g. steps or sub-tasks of an overall task. Then for one or more tasks of the series of tasks, e.g. for each task, e.g. until a final task of the series the digital assistant can be used to output to the user an indication of the task, e.g. step or sub-task, to be performed. This may be done using natural language, e.g. on a display and/or using a speech synthesis subsystem of the digital assistant. Visual, e.g. video, and/or audio observations of the user performing the task may be captured, e.g. using the digital assistant. A system as described above may then be used to determine whether the user has successfully achieved the task e.g. step or sub-task, i.e. from the answer as previously described. If there are further tasks to be completed the digital assistant may then, in response, progress to the next task (if any) of the series of tasks, e.g. by outputting an indication of the next task to be performed. In this way the user may be led step-by-step through a series of tasks to perform an overall task. During the training of the generative neural network 102, training rewards may be generated e.g. from video data representing examples of the overall task (if corpuses of such data are available) or from a simulation of the overall task.

In a further aspect there is provided a digital assistant device including a system as described above. The digital assistant can also include a user interface to enable a user to request assistance and to output information. In implementations this is a natural language user interface and may comprise a keyboard, voice input-output subsystem, and/or a display. The digital assistant can further include an assistance subsystem configured to determine, in response to the request, a series of tasks for the user to perform. In implementations this may comprise a generative (large) language model, in particular for dialog, e.g. a conversation agent such as Sparrow (Glaese et al. arXiv:2209.14375) or Chinchilla (Hoffmann et al. arXiv:2203.15556). The digital assistant can have an observation capture subsystem to capture visual and/or audio observations of the user performing a task; and an interface for the above-described language model neural network (which may be implemented locally or remotely). The digital assistant can also have an assistance control subsystem configured to assist the user. The assistance control subsystem can be configured to perform the steps described above, for one or more tasks e.g. of a series of tasks, e.g. until a final task of the series. More particularly the assistance control subsystem and output to the user an indication of the task to be performed, capture, using the observation capture subsystem, visual or audio observations of the user performing the task, determine from the above-described answer whether the user has successfully achieved the task. In response the digital assistant can progress to a next task of the series of tasks and/or control the digital assistant, e.g. to stop capturing observations.

As another example, the task can be a genomics task, where the network input is a sequence representing a fragment of a DNA sequence or other molecule sequence and the network output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

In some cases, the machine learning task is a combination of multiple individual machine learning tasks, i.e., the system is configured to perform multiple different individual machine learning tasks, e.g., two or more of the machine learning tasks mentioned above. For example, the system can be configured to perform multiple individual natural language understanding tasks, with the network input including an identifier for the individual natural language understanding task to be performed on the network input.

In some cases, the machine learning task is a multi-modal processing task that requires processing multi-modal data. In general, multi-modal data is a combination of two or more different types of data, e.g., two or more of audio data, image data, text data, or graph data. As one example the multi-modal data may comprise audio-visual data, comprising a combination of pixels of an image or of video and audio data representing values of a digitized audio waveform. As another example the multi-modal data may comprise a combination of i) text data representing text in a natural language and ii) pixels of an image or of video or audio data representing values of an audio waveform. Optionally, but not necessarily, the different types of data may represent the same or overlapping objects using the different modalities (types), and when processing multi-modal data the data may be mapped into a common embedding space.

As a particular example, the task is a multi-modal processing task that requires processing both text and image inputs, so that the neural network includes both a computer vision neural network and a text processing neural network. That is, the target output to be generated by the computer vision neural network for a given image depends on one or more outputs generated by the text processing neural network for one or more corresponding text inputs (and vice versa). Examples of such tasks include open-vocabulary image classification, open-vocabulary object detection, image captioning, text-based image search, image-based retrieval, and so on.

More generally, the multi-modal processing task may correspond to any of the tasks previously described for any of the types of data making up the multi-modal combination. For example, an accuracy of the previously described tasks may be increased when the task is applied to multi-modal data combining the data for which the task has been previously described and another type of data. For example detection or classification of an object or event may be improved when data of multiple different types (modalities) is processed.

In particular, the generative neural network 102 is capable of receiving network inputs and generating network outputs for multiple different machine learning tasks. Generally, two machine learning tasks are different if they have different desired outputs for the inputs received for the tasks. For example, two image classification tasks can be different if the object categories into which each task requires classifying input images are different. As another example, two robot learning tasks can be different if the two tasks require generating outputs defining actions to be performed by a robot to reach two different goals.

In practice, for any of these examples, the task to be performed by the neural network can be defined by (at least a part of) the network input, e.g., that is in the form of a prompt or a request, received by the neural network. In other words, the neural network will be able to perform any of these tasks when an appropriate prompt or request is received.

In some situations, the generative neural network 102 can be referred to as an auto-regressive neural network when the neural network auto-regressively generates an output sequence of tokens as a network output. More specifically, the auto-regressively generated output is created by generating each particular token in the output sequence conditioned on a current input sequence that includes an input sequence included in the network input and any tokens that precede the particular token in the output sequence, i.e., the tokens that have already been generated for any previous positions in the output sequence that precede the particular position of the particular token.

The generative neural network can, for example, have any of a variety of Transformer-based neural network architectures, e.g., encoder-only Transformer architectures, encoder-decoder Transformer architectures, decoder-only Transformer architectures, diffusion Transformer architectures, other attention-based architectures, and so on.

Examples of such Transformer-based neural network architectures include those described in Colin Raffel, et al., Exploring the limits of transfer learning with a unified text-to-text transformer. arXiv preprint arXiv:1910.10683, 2019; Daniel Adiwardana, et al., Towards a human-like open-domain chatbot. CoRR, abs/2001.09977, 2020; Aakanksha Chowdhery, et al., PaLM: Scaling Language Modeling with Pathways, arXiv preprint arXiv:2204.02311; Rohan Anil, et al. Palm 2 technical report. arXiv preprint arXiv:2305.10403, 2023; and Gemini Team, et al., Gemini: a family of highly capable multimodal models. arXiv preprint arXiv:2312.11805 (2023).

For example, the generative neural network 102 may be a generative language model neural network. Examples of generative language model neural networks include Sparrow (Glaese et al. arXiv:2209.14375), Chinchilla (Hoffmann et al. arXiv:2203.15556), and PaLM 2 (Anil, et al. arXiv:2305:10403). As another example, the generative neural network 102 may be a multi-modal model neural network, e.g., a vision language model (VLM) neural network. Examples of multi-modal neural networks include Flamingo (Alayrac et al. arXiv:2204.14198), PaLI (Chen et al. arXiv:2209.06794), and PaLI-X (Chen et al. arXiv:2305.18565).

As another example, the generative neural network may be a foundation model neural network. A foundation model neural network is a large-scale machine learning model trained on a broad data set that can be adapted and fine-tuned for a wide variety of applications and downstream tasks. Examples of foundation model neural networks include Imagen (Saharia et al. arXiv:2205.11487) and Parti (Yu et al. arXiv:2206.10789).

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
receiving a plurality of training examples, each training example comprising (i) a training query for a task to be performed and (ii) a target response to the training query;
at each of a plurality of training steps:
identifying one or more current training examples for the training step; and
for each of one or more training epochs:
selecting one or more context examples for each current training example from a subset of the plurality of training examples that does not include the current training example;
generating a modified training example for each current training example, each modified training example comprising (i) the training query, (ii) a few-shot prompt that comprises the selected context examples, and (iii) the target response to the training query; and
training a generative neural network using the modified training examples.

2. The method of claim 1, wherein training the generative neural network comprises:
training the generative neural network using gradients of an objective function that measures, for each modified training example, a likelihood assigned by the generative neural network to the target response in the modified training example by processing the training query and the few-shot prompt in the training example.

3. The method of claim 2, wherein the likelihood is a log-likelihood.

4. The method of claim 1, wherein, prior to the training using the modified training example, the generative neural network has been trained on one or more pre-training data sets.

5. The method of claim 1, further comprising, at each training step of the plurality of training steps, before training the generative neural network for the one or more training epochs at the training step:
selecting a test training example from the plurality of training examples;
selecting one or more test context examples from a second subset of the plurality of training examples that does not include the test training example;
processing an input comprising (i) the training query of the test training example and (ii) a few-shot prompt that comprises the selected test context examples using the generative neural network to generate a training response to the training query; and
updating a cumulative loss function based on a similarity between the target response to the training query and the training response to the training query.

6. The method of claim 5, further comprising calculating a prequential loss metric using the cumulative loss function.

7. The method of claim 6, wherein calculating the prequential loss metric comprises, after performing the plurality of training steps, dividing the cumulative loss function by a number of training examples in the plurality of training examples.

8. The method of claim 5, wherein identifying one or more current training examples for the training step includes selecting the test training example as a current training example.

9. The method of claim 5, wherein updating the cumulative loss function comprises:
calculating a next step loss based on a similarity between the target response to the training query and the training response to the training query; and
adding the next step loss to the cumulative loss function.

10. The method of claim 5, wherein the training examples in the second subset of the plurality of training examples are the current training examples used to train the generative neural network at preceding training steps.

11. The method of claim 1, wherein each modified training example further comprises an instruction for the task.

12. The method of claim 5 wherein, for each training step, the same number of selected context examples is selected for each current training example for each training epoch.

13. The method of claim 12, wherein the number of selected context examples for each current training example is the same as the number of selected test context examples.

14. The method of claim 1, wherein the training examples in the subset of the plurality of training examples are the current training examples used to train the generative neural network at preceding training steps.

15. The method of claim 14, wherein selecting the one or more context examples for each current training example comprises:
determining whether more than a maximum number of current training examples have been used to train the generative neural network at preceding training steps;
in response to determining that more than the maximum number of current training examples have not been used, selecting each of the current training examples that have been used to train the generative neural network at preceding training steps; and
in response to determining that more than the maximum number of current training examples have been used, selecting the maximum number of current training examples from the current training examples that have been used to train the generative neural network at preceding training steps.

16. The method of claim 1, wherein:
each training step is associated with a different one of the training examples;
the one or more current training examples for each training step include only the training example associated with the training step; and
a total number of training steps in the plurality of training steps is equal to a total number of training examples in the plurality of training examples.

17. The method of claim 1, further comprising, after training:
receiving a query for a task to be performed;
selecting one or more inference context examples from the plurality of training examples;
generating a few-shot prompt comprising the selected inference context examples; and
processing (i) the query and (ii) the few-shot prompt using the generative model to generate a response to the query.

18. The method of claim 1, wherein each context example comprises an image and a text segment, and wherein the generative neural network is trained to output a text segment.

19. A system comprising:
one or more computers; and
one or more storage devices communicatively coupled to the one or more computers, wherein the one or more storage devices store instructions that, when executed by the one or more computers, cause the one or more computers to perform operations comprising:
receiving a plurality of training examples, each training example comprising (i) a training query for a task to be performed and (ii) a target response to the training query;
at each of a plurality of training steps:
identifying one or more current training examples for the training step; and
for each of one or more training epochs:
selecting one or more context examples for each current training example from a subset of the plurality of training examples that does not include the current training example;
generating a modified training example for each current training example, each modified training example comprising (i) the training query, (ii) a few-shot prompt that comprises the selected context examples, and (iii) the target response to the training query; and
training a generative neural network using the modified training examples.

20. One or more non-transitory computer storage media storing instructions that when executed by one or more computers cause the one or more computers to perform operations comprising:
receiving a plurality of training examples, each training example comprising (i) a training query for a task to be performed and (ii) a target response to the training query;
at each of a plurality of training steps:
identifying one or more current training examples for the training step; and
for each of one or more training epochs:
selecting one or more context examples for each current training example from a subset of the plurality of training examples that does not include the current training example;
generating a modified training example for each current training example, each modified training example comprising (i) the training query, (ii) a few-shot prompt that comprises the selected context examples, and (iii) the target response to the training query; and
training a generative neural network using the modified training examples.
